(19) United States
(12) Patent Application Publication
(10) Pub. No.: US 2025/0108497 A1
(43) Pub. Date: Apr. 3, 2025

(54) MULTI-PURPOSE TOOLS, INSERTS, AND METHODS RELATING TO THE SAME

(71) Applicant: Chancellor W. Hemphill, Wilmington, DE (US)

(72) Inventor: Chancellor W. Hemphill, Wilmington, DE (US)

(21) Appl. No.: 18/905,467

(22) Filed: Oct. 3, 2024

Related U.S. Application Data
(60) Provisional application No. 63/542,213, filed on Oct. 3, 2023.
(60) Provisional application No. 63/544,260, filed on Oct. 16, 2023.

(51) Int. Cl. B25F 1/00

(52) U.S. Cl. CPC B25F 1/00

(57) ABSTRACT

Multi-purpose tools, inserts, and methods that facilitate the installation of a fiber reinforced polymer in a concrete structure that includes a first tool portion that is configured to mix or spread at least one material, wherein the first tool portion is located at a first end of a handle member; and a second tool portion comprising an elongated body having a proximal end and a distal end, wherein the proximal end is located at a second end of the handle member.

### REFERENCED APPLICATIONS

The present patent application claims the benefit of U.S. Provisional Patent Application Ser. No. 63/542,213 filed on Oct. 3, 2023 and entitled “Spatula and Insertion Tool”, and U.S. Provisional Patent Application Ser. No. 63/544,260 filed on Oct. 16, 2023 and entitled “Spatula and Insertion Tool Package Insert”, the disclosures of which are hereby incorporated by reference herein in their entireties and made part of the present U.S. utility patent application for all purposes.

### TECHNICAL FIELD

The present disclosure relates generally to multi-purpose tools, and more particularly to a combination spatula and insertion tool, and even more particularly to a combination spatula and insertion tool that facilitates the installation of near surface mounted fiber reinforced polymer products. The present disclosure further pertains to spatula and insertion tool package inserts that can be conveniently packaged with the fiber reinforced polymer products.

### BACKGROUND OF DISCLOSURE

Near Surface Mounting (NSM) is a technique that has been developed over the years by the concrete repair industry and has become the generally accepted way to repair pre-cast concrete double tees, among other structures. NSM generally involves the installation of fiber reinforced polymers (FRP) in slots or channels formed into concrete.

In conventional NSM procedures, 0.25 inch or wider slots are typically cut to a prescribed depth (typically about 1-4 inches) in the top surface of the concrete structure. An adhesive, typically a two-part epoxy, is commonly mixed using a spatula or trowel tool. The adhesive is used to secure the FRP within the formed slot in the concrete. After the adhesive is optionally mixed by the spatula, the spatula is then used to spread the adhesive onto the FRP component.

Prior to the FRP being inserted into the slot, the adhesive is typically dispersed and/or pushed into the formed slot using another, separate tool such as a tuck pointer. The tuck pointer is typically about 0.25-0.375 inches wide, less than about 0.25 inches thick, and bent to accept an offset handle. During installation of the FRP, the tuck pointer tool is used to place the FRP (typically partially covered with adhesive) into the slot and push the FRP further into the slot until the FRP is fully seated therein and embedded in the adhesive. The insertion of the FRP into the slot results in a significant amount of excess adhesive displaced from the slot, which needs to be scraped up/off the concrete surface. This scraping up of the adhesive is typically accomplished by using the spatula initially used to mix the adhesive.

The adhesives used to secure the FRP in the slots are extremely sticky and difficult to clean off surfaces. Cleaning of the adhesives typically requires the use of aggressive solvents such as acetone and methyl ethyl ketone. Additionally, the adhesives have a generally rapid cure time (e.g., less than an hour), thereby causing the adhesives to quickly bond to a surface in matter of minutes. Once substantially or fully cured, the adhesives are essentially impossible to remove, except by use of abrasive means (e.g., grinding off the adhesive, chipping off the adhesive, etc.). Non-limiting FRPs and FRP adhesives and methods the use of such FRPs and FRP adhesives are discloses in U.S. Pat. No. 12,054,959; U.S. Pat. No. 9,194,140; and U.S. Pat. No. 8,567,146, which are all incorporated fully herein by reference.

As such, conventional NSM techniques requires the need for two distinctly different tools to install the FRP: (i) a plastic spatula that needs to be disposed of after each FRP installation; and (ii) a steel tuck pointer. Because the steel tuck pointers are expensive and not always readily available, the tuck pointer is typically immediately cleaned of the adhesive using a solvent. Such cleaning process is time consuming, difficult, potentially hazardous to the cleaner (depending on the type of solvent used), and typically environmentally unfriendly due to required solvents needed to remove the adhesive from the tuck pointer.

In view of the problems associated with the tools required to mix adhesives and insert a FRP into a cut slot, there is a need for a single tool that: (1) can be used to mix the required adhesive for a FRP; (2) facilitates inserting the adhesive into the slot; (3) facilitates inserting the FRP into the slot; (4) can be used to clean up excess adhesive about the slot once the FRP is inserted into the slot; and (5) is inexpensive and can be disposed of after use, thereby eliminating the need to clean the tool with undesirable solvents. There is further a need for a disposable system/package insert that is in the form of a single piece of material that has been partially cut, grooved, etched, etc. to enable a user to manually separate the single piece of material into an adhesive mixing surface, a spatula tool, and a tuck pointer tool, without the need for additional tools.

### SUMMARY OF DISCLOSURE

The present disclosure is directed to multi-purpose tools, and more particularly to a combination spatula and insertion tool, and even more particularly to a combination spatula and insertion tool that facilitates the installation of near surface mounted fiber reinforced polymer products. In particular, the present non-limiting disclosure is directed to a multi-purpose tool that includes a first tool portion that is configured to mix or spread at least one material, wherein the first tool portion is located at a first end of a handle member; and a second tool portion comprising an elongated body having a proximal end and a distal end, wherein the proximal end is located at a second end of the handle member.

In one non-limiting aspect of the present disclosure, the first tool portion comprises a substantially flat body having a rear portion and a front portion that has a beveled front edge. In some non-limiting, alternative embodiments, the rear portion tapers inward towards the first end of the handle member, wherein the front portion has a first predetermined width and the rear portion has a second predetermined width, and wherein the first predetermined width is greater than the second predetermined width. In some non-limiting embodiments, the first tool portion is a spatula.

In another non-limiting aspect of the present disclosure, the first tool portion is integrally formed with the first end of the handle member, and wherein the second tool portion is integrally formed with the second end of the handle member.

In another or alternative non-limiting embodiment, first tool portion is coupled to the first end of the handle member, and wherein the second tool portion is coupled to the second end of the handle member.

In some non-limiting aspects of the present disclosure, the distal end of the second tool portion includes a beveled edge.

In some non-limiting aspects of the present disclosure, the elongated body of the second tool portion includes a first portion and a second portion, wherein the first portion is offset from the second portion.

In some non-limiting aspects of the present disclosure, the second tool portion is a tuck pointer. In certain non-limiting aspects of the present disclosure, the multi-purpose tool facilitates the installation of at least one fiber reinforced polymer in at least one slot that is formed in a structure, and wherein the at least one material is an adhesive that is configured for use with the at least one fiber reinforced polymer.

In some non-limiting aspects of the present disclosure, the multi-purpose tool has a longitudinal length of 14-18 inches, and the multi-purpose tool has a maximum thickness of 0.15-0.5 inches.

In another non-limiting aspect of the present invention, there is provided a packaging insert that includes the first tool portion and the second tool portion, wherein the packaging insert further comprises a surface member, and wherein the packaging insert is formed of a single piece of material that includes a plurality of perforations separating the first tool portion, the second tool portion, and the surface member.

Another and/or alternative non-limiting object of the present disclosure is directed to a tool that facilities the installation of a fiber reinforced polymer in a concrete structure. In one non-limiting aspect of the present disclosure, the tool includes a spatula having a beveled front edge that is configured to mix or spread at least one adhesive, wherein the spatula is integrally formed with a first end of a handle member; and an insertion tool having an elongated body that is configured to insert the at least one adhesive and a fiber reinforced polymer in at least one slot formed in a concrete structure, wherein the elongated body includes a proximal end and a distal end, wherein the proximal end is integrally formed with a second end of the handle member.

In one non-limiting aspect of the present invention, the spatula comprises a substantially flat body having a rear portion and a front portion, wherein the rear portion is integrally formed with the first end of the handle member, and wherein the front portion includes the beveled front edge. In another and/or alternative non-limiting aspect of the present invention, the rear portion tapers inward towards the first end of the handle member, wherein the front portion has a first predetermined width and the rear portion has a second predetermined width, and wherein the first predetermined width is greater than the second predetermined width.

In some non-limiting aspects of the present invention, the distal end of the insertion tool includes a beveled edge. In some non-limiting aspects of the present invention, the elongated body of the insertion tool includes a first portion and a second portion, wherein the first portion is offset from the second portion. In some non-limiting aspects of the present invention, the insertion tool is a tuck pointer.

In certain non-limiting aspects of the present invention, the tool has a longitudinal length of 14-18 inches, and the tool has a maximum thickness of 0.15-0.5 inches.

In certain non-limiting aspects of the present invention, the rear portion of the spatula has a longitudinal length of 1.5-4 inches; the front portion of the spatula has a longitudinal length of 2-4 inches; the insertion tool has a longitudinal length of 5-11 inches; and the handle member has a longitudinal length of 3-6 inches.

These and other objects and advantages will become apparent to those skilled in the art upon reading and following the description taken together with the accompanying drawings.

### BRIEF DESCRIPTION OF THE DRAWINGS

The accompanying drawings, which are incorporated into and form a part of the specification, schematically illustrate one or more example implementations of the disclosed technology and, together with the general description given above and detailed description given below, serve to explain the principles of the disclosed subject matter, and wherein:

FIG. 1 is a front perspective view of a non-limiting, exemplary tool in accordance with the present disclosure.

FIG. 2 is a front elevation view of the tool of FIG. 1.

FIG. 3 is a rear elevation view of the tool of FIG. 1.

FIG. 4 is a right side view of the tool of FIG. 1.

FIG. 5 is a left side view of the tool of FIG. 1.

FIG. 6 is a top plan view of the tool of FIG. 1.

FIG. 7 is a bottom plan view of the tool of FIG. 1.

FIG. 8 is a front perspective view of a non-limiting, exemplary package insert in accordance with the present disclosure.

FIG. 9 is a top plan view of the package insert of FIG. 8.

FIG. 10 is a bottom plan view of the package insert of FIG. 8.

### DETAILED DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

Example implementations of the disclosed technology provides a multi-purpose spatula and insertion tool that facilitates the installation of near surface mounted (NSM) fiber reinforced polymer (FRP) products in slots or similar channels formed in concrete structures. The disclosed technology advantageously provides a single (i.e., monolithically formed or unibodied), disposable tool that can be used to mix the required adhesive for a FRP, insert the adhesive and FRP into the slot, and clean up excess adhesive about the slot once the FRP is inserted. The disclosed tool can be formed of a variety of durable materials, such as, but not limited to, plastic material, wood, metal, ceramic, composite material, etc., and/or a variety of polymeric materials, such as, but not limited to, polyethylene, polypropylene, polyvinyl chloride, etc. In certain non-limiting implementations, the tool can be formed by 3D printing, molding, casting, stamping, cutting, etc. Although the disclosed technology is described in relation to FRPs in concrete applications, it is to be appreciated that the disclosed tool can be used in various other applications (e.g. brickwork, seamwork, mortaring, etc.) and in various other types of structures (e.g. stone, granite, marble, steel, etc.).

Other example implementations of the disclosed technology provides a disposable system/package insert that is formed of a single piece of material that has been partially cut, grooved, etched, etc. to enable a user to manually separate the single piece of material into an adhesive mixing surface member, a spatula tool, and a tuck pointer tool, without the need for additional tools. The disclosed package insert is configured to fit into a base or bottom of a package that is commonly used to when shipping the adhesive(s) and FRP(s) for NSM. The disclosed package insert advantageously: (i) provides a one-piece system that can be easily and conveniently packaged in existing adhesive(s) and FRP(s) packaging; (ii) provides a disposable system at can be conveniently disposed of after use; (iii) provides a one-piece system that can easily and conveniently be separated by hand and without the need for additional tooling; and (iv) provides a degradable and more environmentally friendly system for use in mixing adhesives and for inserting FRPs into the formed slot. In certain non-limiting implementations, the disclosed package insert is formed of a single piece of material formed of wood, fiber board, particle board, or combinations thereof.

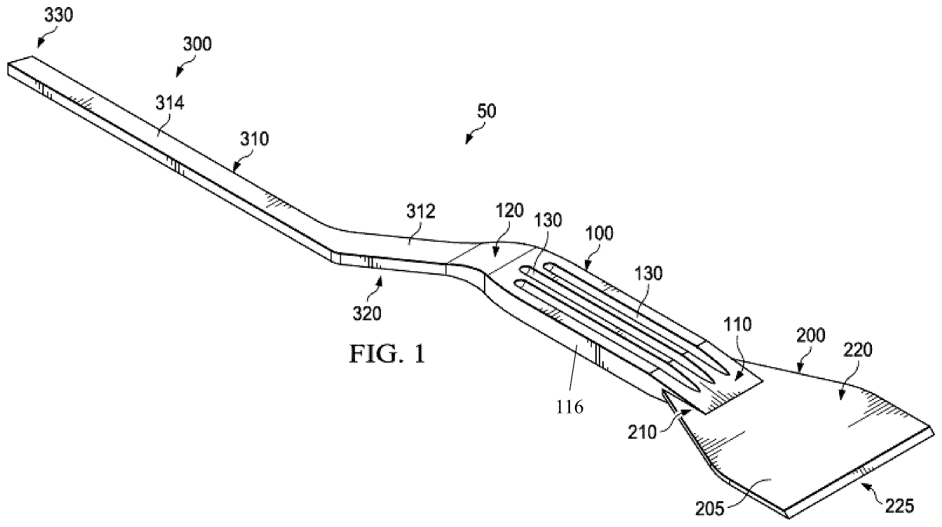

One or more implementations of the subject application will now be described with reference to the attached FIGS. 1-10, wherein like reference numerals are used to refer to like elements throughout.

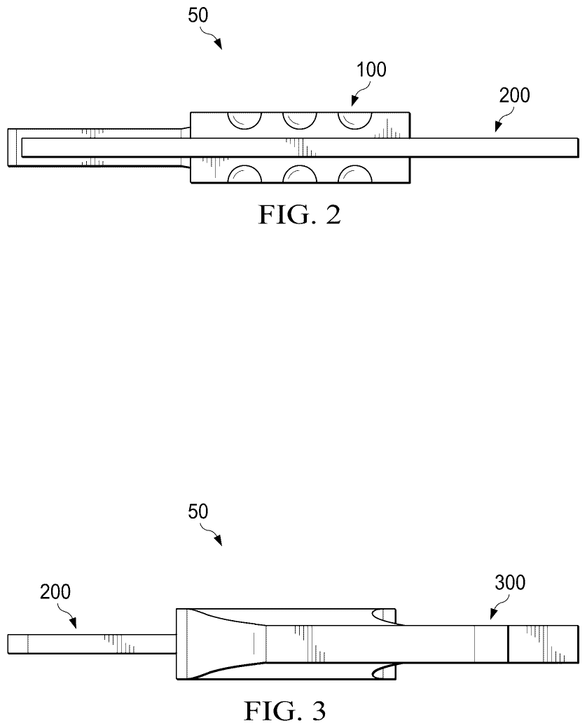

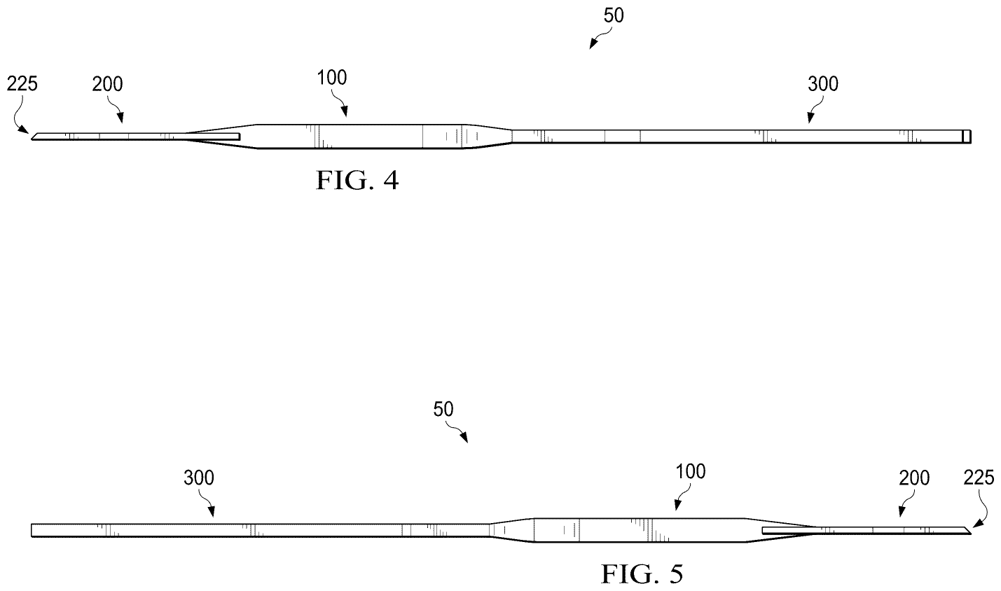

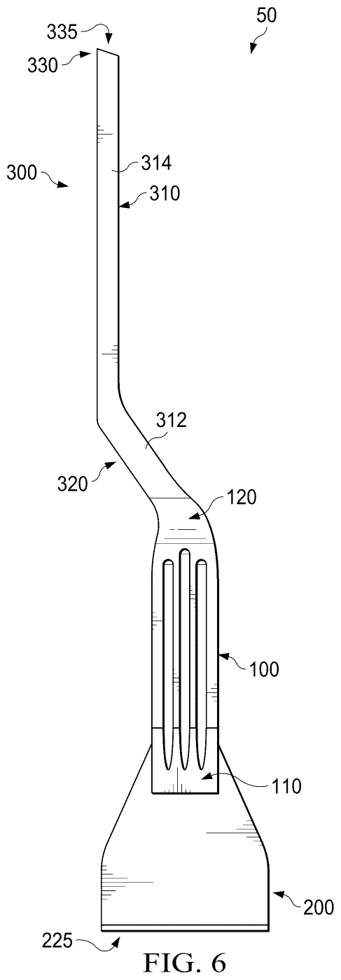

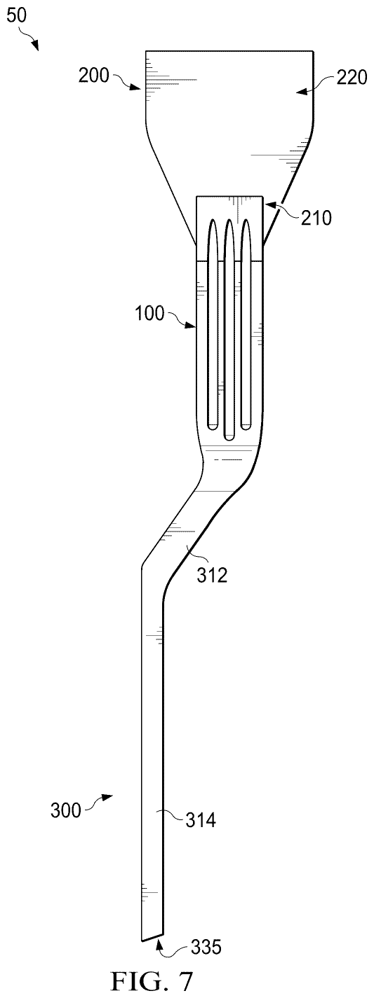

FIG. 1 is a front perspective view of a non-limiting, exemplary tool 50 in accordance with the present disclosure. FIG. 2 is a front elevation view of the tool 50 of FIG. 1. FIG. 3 is a rear elevation view of the tool 50 of FIG. 1. FIG. 4 is a right side view of the tool 50 of FIG. 1. FIG. 5 is a left side view of the tool 50 of FIG. 1. FIG. 6 is a top plan view of the tool 50 of FIG. 1. FIG. 7 is a bottom plan view of the tool 50 of FIG. 1.

With reference to FIGS. 1-7, exemplary tool 50 includes a connector 100, a first tool portion 200, and a second tool portion 300. The connector 100 includes a first end portion 110, a second end portion 120, a mid-portion 116 and a plurality of channels 130 formed through the connector 100. The one or channel may or may not pass fully through connector 100. The one or more channels can optionally a) reduce the weight of the connector, and/or b) provide flexibility to the connector during use. In the present non-limiting embodiment, the first tool portion 200 is integrally formed with the first end 110 of the connector 100, and the second tool portion 300 is integrally formed with the second end 120 of the connector 100. In the present non-limiting embodiment, the connector 100 is configured as a handle when using either the first tool portion 200 or the second tool portion 300.

Still referring to FIGS. 1-7, the first tool portion 200 is a spatula, scrapper, or similar trowel tool that is configured to mix and/or spread an FRP adhesive and clean up or scrape off excess or misapplied adhesive. The first tool portion 200 comprises a body 205 having a rear portion 210 and a front portion 220 that has a beveled front edge 225, wherein the rear portion 210 is integrally formed with or connected to the first end 110 of the connector 100. The rear portion 210 optionally has a narrower width as compared to the front portion 220. In the present non-limiting embodiment, the first tool portion 200 includes a wide front portion 220 and a narrower rear portion 210 that tapers inward toward the first end 110 of the connector 100. The front portion 220 optionally has a constant width along a longitudinal length of the front portion 220. The front portion that is spaced rearward of the beveled front edge 225 can optionally have a constant thickness. In the present non-limiting embodiment, the beveled front edge 225 is a working edge for mixing, spreading, and cleaning or scraping off the FRP adhesive. In the present non-limiting embodiment, the body 205 is a blade.

Connector 100 can optionally include a slot (not shown) at the front end portion 112 to receive a portion of the narrower rear portion 210 of first tool portion 200. When the first tool portion 200 is configured to be connected to connector 100, an adhesive and/or melted connection can be used to secure the first tool portion 200 to connector 100.

The front end portion 110 of connector 100 can optionally taper in thickness.

Connector 110 is illustrated in FIG. 1 to have a front end portion 112, a mid-portion 116 and an end portion 120. The mid-portion has optionally has a generally constant side thickness along a longitudinal length of the mid-portion 116. The rear end region of the mid-portion can optionally taper in width at the region of connection with the end portion 120 of the connector 100. The end portion 120 can optionally be configured such that both the thickness and width of the end portion 120 varies along the longitudinal length of the end portion. As illustrated in FIG. 1, both the thickness and width of the end portion 120 reduces from the front end region that is connected to the mid-portion 116 to the rear end region that is connected to the second tool portion 300. The channels 130 are illustrated a only being in the front end portion 112 and mid-portion 116 of connector 130, and are positioned parallel to one another. The length of one or more of the channels 130 can optionally be different. End portion 120 can optionally include arcuate side regions that transition into the second tool portion 300,

Still referring to FIGS. 1-7, the second tool portion 300 is a tuck pointer, insertion tool, or similar trowel tool that is configured to insert the FRP and the FRP adhesive into the slot formed in the concrete structure. The second tool portion 300 comprises an elongated body 310 having a proximal end 320 and a distal end 330. The proximal end 320 is can optionally be integrally formed with the second end portion 120 of the connector 100. The distal end 330 optionally includes a beveled edge 335. The body 310 includes a first portion 312 and a second portion 314, wherein the first portion 312 is offset or angled from the second portion 314. In the present non-limiting embodiment, the body 310 is a pole/blade that aids in the insertion and/or compressing of the FRP, and the FRP adhesive, into the formed slot. The thickness of the second tool portion 300 can be constant along 60-100% (and all values and ranges therebetween) the longitudinal length of the second tool portion 300. The width of the second tool portion 300 can be constant along 60-100% (and all values and ranges therebetween) the longitudinal length of the second tool portion 300. As illustrated in FIGS. 4 and 5, the thickness of the second tool portion 300 is constant along at least 80% of the longitudinal length of the second tool portion 300. As illustrated in FIGS. 6 and 7, the width of the second end portion 314 is narrower than 80-100% (and all values and ranges therebetween) the width of the first portion 312. The first portion 312 can optionally include arcuate regions that transition into the second end portion 314. As illustrated in FIGS. 4 and 5, the thickness of the first tool portion 200 has the smallest thickness and the connector 100 has the largest thickeness. As illustrated in FIGS. 6 and 7, the first tool portion 200 has the largest width, and the second tool portion 300 has the smallest or narrowest width. The longitudinal length of the first portion 312 is generally less than the longitudinal length of the second end portion 314 (e.g., the longitudinal length of the first portion is 1.5-4 times shorter [and all values and ranges therebetween] the longitudinal length of the second end portion). Generally, the longitudinal length of the second tool portion 300 is optionally greater than the longitudinal length of the connector 100 or the first tool portion 200, and longitudinal length of the second tool portion 300 is optionally greater than the combined longitudinal length of the connector 100 and the first tool portion 200. The longitudinal axis of a majority (e.g., 80-99.99% and all values and ranges therebetween) or all of the second end portion 314 is generally parallel to a majority (e.g., 80-99.99% and all values and ranges therebetween) or all of the longitudinal axis of the connector 100 and/or the first tool portion 200. The longitudinal axis of a majority (e.g., 80-99.99% and all values and ranges therebetween) or all of the second end portion 314 is generally non-parallel to a majority (e.g., 80-99.99% and all values and ranges therebetween) or all of the longitudinal axis of the first end portion 312.

In one non-limiting method for near surface mounting fiber reinforced polymer products in concrete structures using the disclosed tool 50 illustrated in FIGS. 1-7, the following steps are performed: (i) gripping the connector 100, (ii) optionally using the connector 100 and/or other portions of tool 50 to mix together one or more components of the FRP adhesive; (iii) optionally applying or spreading the FRP adhesive to a FRP using the first tool portion 200 and/or other portions of tool 50; (iv) applying/inserting the FRP into a slot (e.g., preformed slot in a concrete structure, etc.) by way of the second tool portion 300 and/or other portions of tool 50; (v) using the second tool portion 300 and/or other portions of tool 50 to insert the FRP down into the preformed slot until the FRP is properly seated or position in the slot; (vi) optionally inserting FRP adhesive into the slot that includes the FRP until a majority (e.g., 80-99.99% and all values and ranges therebetween) or all of the remaining voids in the slot are filled with the FRP adhesive; (vii) optionally using the first tool portion 200 and/or other portions of tool 50 to (a) desirably spread the FRP adhesive on a surface of the concrete about the slot, (b) properly position the FRP that extends from the slot in a location about the slot, and/or (c) spread FRP adhesive over the FRP that extends upwardly and about the slot; (viii) optionally clean or scrape off excess or unwanted FRP adhesive around or about the concrete structure; and (iv) subsequent to cleaning or scrapping off the FRP adhesive, optionally disposing of the tool 50. It is to be understood that the disclosed method can be performed in other various applications (e.g. brickwork, seamwork, mortaring, etc.) and in various other types of structures (e.g. stone, granite, marble, steel, etc.) and may or may not use a FRP. As can be appreciated, in other applications, an adhesive other than a FRP adhesive can be used.

It will be appreciated that any of a variety of additional or alternative steps may be included in a method of using the tool 50.

It is to be appreciated that the connector 100, the first tool portion 200, and the second tool portion 300 can be individual pieces (i.e. non-unibody) that can be coupled together (e.g. via screws, snaps, mechanical fasteners, adhesive, melted connection, etc.) to form tool 50. It is to be appreciated that the body 310 of the second tool portion 300 could have an elongated, completely linear profile. It is to be appreciated that the distal end 330 could optionally include a flat edge or a rounded edge.

In one non-limiting embodiment, the tool 50 has a length of about 10-25 inches (and all values and ranges therebetween), and more particularly about 14-18 inches (e.g. 16-17 inches). The maximum thickness of the tool 50 is about 0.1-3 inches (and all values and ranges therebetween), and typically 0.15-0.5 inches.

In one non-limiting embodiment, the maximum width of the front portion 220 of the first tool portion 200 is about 1.5-8 inches (and all values and ranges therebetween), and typically 2-5 inches. In one-limiting embodiment, the longitudinal length of the front portion 220 is about 1.5-8 inches (and all values and ranges therebetween), and typically 2-4 inches. In one non-limiting embodiment, the longitudinal length of the rear portion 210 of the first tool portion 200 is about 1-6 inches (and all values and ranges therebetween), and typically 1.5-4 inches. In one non-limiting embodiment, the longitudinal length of the front portion 220 is less than the longitudinal length of the rear portion 230. In one non-limiting embodiment, the average thickness of the front portion 220 of the first tool portion 200 is about 0.05-0.4 inches (and all values and ranges therebetween), and typically 0.1-0.3 inches. In one non-limiting embodiment, the average thickness of the rear portion 210 of the first tool portions 200 is about 0.1-0.7 inches (and all values and ranges therebetween), and typically 0.2-0.5 inches. In one non-limiting embodiment, the average thickness of the front portion 220 is less than the average thickness of the rear portion 230. In one non-limiting embodiment, the beveled front edge 225 includes an angle of about 20-80° (and all values and ranges therebetween), and typically 30-60°.

In one non-limiting embodiment, the second tool portion 300 is about 4-14 inches in longitudinal length (and all values and ranges therebetween), and typically 5-11 inches. In one non-limiting embodiment, the width of the second tool portion 300 is about 0.25-1.5 inches (and all values and ranges therebetween), and typically 0.3-0.5 inches. It is to be appreciated that the width of the second tool portion 300 can be constant or can vary along its length. In one non-limiting embodiment, the thickness of the second tool portion 300 is about 0.1-0.75 inches (and all values and ranges therebetween), and typically 0.1-0.3 inches. It is to be appreciated that the thickness of the second tool portion 300 can be constant or can vary along its length. In one non-limiting embodiment, the beveled edge 335 is angled about 0.05-0.5 inches (and all values and ranges therebetween), and typically 0.1-0.2 inches.

In one non-limiting embodiment, the connector 100 is shorter in length than that of the second tool portion 300 and has an average width that is greater than that of the second tool portion 300. In one non-limiting embodiment, the connector 100 is shorter in length than that of the first tool portion 200 and has an average width that is less than that of the first tool portion 200. In one non-limiting embodiment, the longitudinal length of the connector 100 is about 2-8 inches (and all values and ranges therebetween), and typically 3-6 inches. In one non-limiting embodiment, the width of the connector 100 is about 0.25-1.5 inches (and all values and ranges therebetween), and typically 0.3-0.75 inches. It is to be appreciated that the width of the connector 100 can be constant or can vary along its length. In one non-limiting embodiment, the thickness of the connector 100 is about 0.1-0.75 inches (and all values and ranges therebetween), and typically 0.1-0.3 inches. It is to be appreciated that the thickness of the connector 100 can be constant or can vary along its length.

In one non-limiting embodiment, the longitudinal axis of the connector 100 is oriented at a predetermined angle to the first tool portion 200 and/or the second tool portion 300. In one non-limiting embodiment, the connector 100 is oriented at an angle of 10-90° (and all values and ranges therebetween) relative to the first tool portion 200 and/or the second tool portion 300, and typically 20-50°. In another non-limiting embodiment, the first tool portion 200 and the second tool portion 300 have longitudinal axes that are parallel to one another. In one non-limiting embodiment, the longitudinal axes of the first tool portion 200 and the second tool portion 300 are spaced apart. In one non-limiting example, the first tool portion 200 and the second tool portion 300 have a longitudinal axes that are parallel to one another, and the longitudinal axes are spaced apart from one another a distance of about 1-5 inches (and all values and ranges therebetween), and typically 1-3 inches.

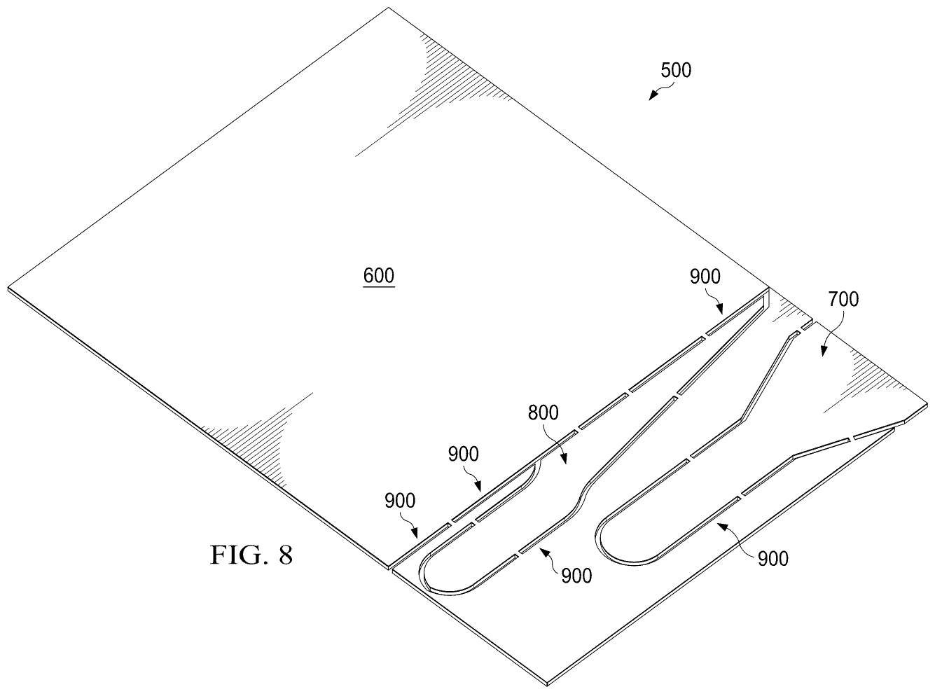

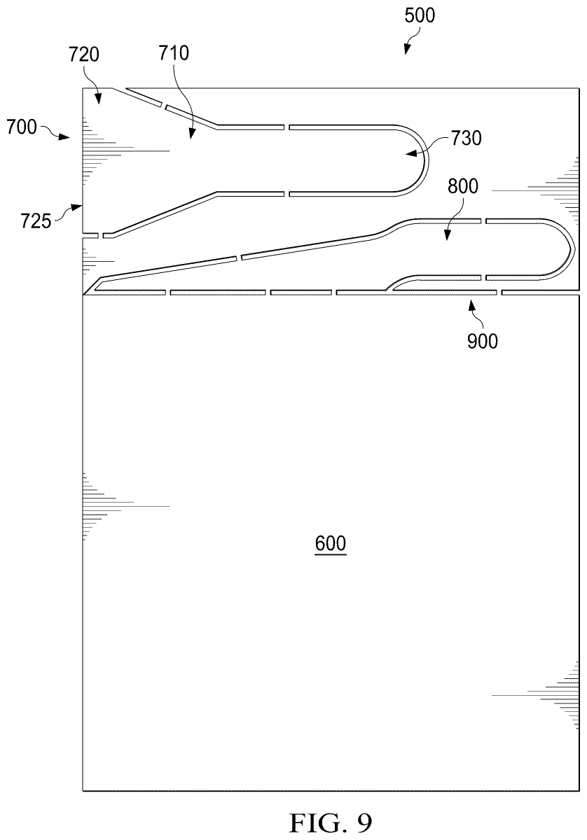

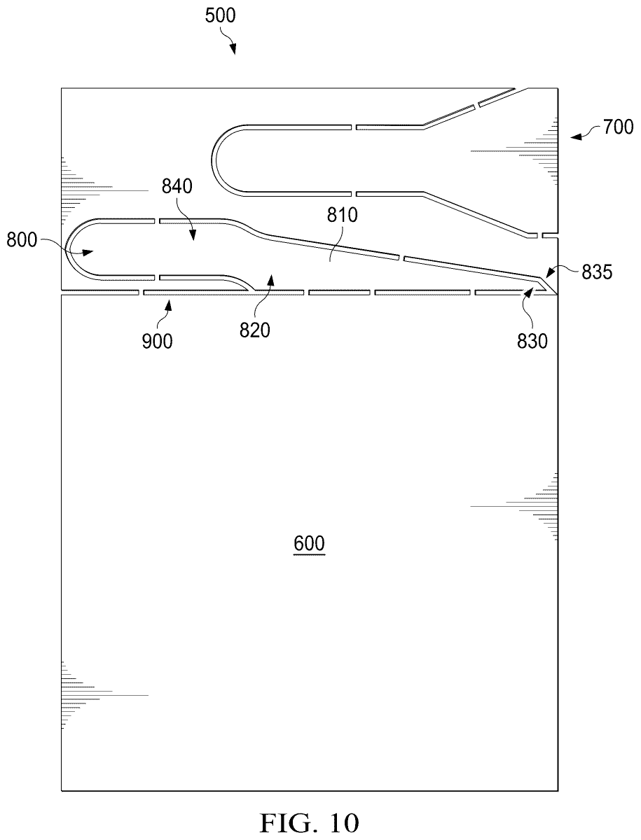

FIG. 8 is a front perspective view of a non-limiting, exemplary package insert 500 in accordance with the present disclosure. FIG. 9 is a top plan view of the package insert 500 of FIG. 8. FIG. 10 is a bottom plan view of the package insert 500 of FIG. 8.

Now referring to FIGS. 8-10, the disclosed package insert 500 comprises a mixing surface member 600, a spatula 700, and an insertion tool 800 that are formed in a single piece of material 850 (e.g., plastic, wood, composite material, ceramic, etc.). The mixing surface member 600, the spatula 700, and the insertion tool 800 are separated by a plurality of break lines 900 or similar perforations, cuts, serrations, grooves, etchings, etc. formed in the single piece of material, to thereby allow for the components of the package insert 500 to be separated without the need for additional tools.

Still referring to FIGS. 8-10, the mixing surface member 600 is useful in mixing multi-component FRP adhesives or other types of adhesives. The components of the FRP adhesives generally need to be mixed prior to use of adhesive. The mixing surface member 600 can also be used as a surface to facilitate the insertion of the adhesive onto the FRP prior to the insertion of the FRP into the slot in the concrete or other type of surface. The mixing surface member 600 can be used as a mobile surface that allows a user to easily pick up and move the adhesive mixing surface member 600 to a location near the slot or to multiple locations when multiple FRPs are to be inserted in different slot locations. Once use of the mixing surface 600 is completed, the mixing surface 600 can optionally be disposed of.

In various non-limiting embodiments, mixing surface member 600 can be: (i) substantially circular having a diameter of about 6-18 inches (and all values and ranges therebetween), and typically about 10-14 inches; (ii) polygonal (e.g., triangular, square, rectangular, hexagonal, etc.) and having a maximum width or dimension of about 6-18 inches (and all values and ranges therebetween), and typically a maximum width or dimension of about 10-12 inches; or (iii) substantially ovular. As can be appreciated, the mixing surface member 600 can have other shapes. In one non-limiting embodiment, the thickness of the mixing surface member 600 can be constant. In one non-limiting embodiment, the thickness of the mixing surface is about 0.1-3 inches (and all values and ranges therebetween), and typically 0.15-0.5 inches. In one non-limiting specific configuration, the mixing surface member 600 is square or rectangular, and has a maximum width or dimension of about 8-14 inches, a constant thickness, and a generally flat or planar top surface.

The spatula 700 includes similar components and functions similarly to that of the first tool portion 200 of tool 50 as discussed above with regard to FIGS. 1-7. The insertion tool 800 includes similar components and functions similarly to that of the second tool portion 300 of the tool 50 as discussed above with regard to FIGS. 1-7. In the present non-limiting embodiment, the spatula 700 is separate from the insertion tool 800 within the package insert 500. In this non-limiting embodiment, the spatula 700 and the insertion tool 800 can optionally be coupled together (e.g. via screws, snaps, mechanical fasteners, adhesive, etc.) to form a single tool that is similar to tool 50 as discussed above with regard to FIGS. 1-7. It is to be appreciated that the spatula 700 and the insertion tool 800 could be integrally formed as a single tool, similar to that of tool 50, within the package insert 500.

Still referring to FIGS. 8-10, the spatula 700 includes a rear portion 710 and a front portion 720 that has a beveled front edge 725, wherein the rear portion 710 is formed with a handle portion 730. In one non-limiting embodiment, the spatula 700 includes a wide front portion 720 and a narrower rear portion 710 that tapers into the handle portion 730. The longitudinal length of the handle portion 730 is generally longer than a combined longitudinal length of the front and rear portions 720, 710. The rear of handle portion 730 can be arcuate.

Still referring to FIGS. 8-10, the insertion tool 800 includes a body 810 having a proximal end 820 and a distal end 830. The body 810 is coupled to a handle portion 840. The distal end 830 includes a beveled edge 835. In the present non-limiting embodiment, the body 810 is a blade that aids in the insertion of the FRP, and the FRP adhesive, into the formed slot. An arcuate transition region can exist between body 810 and handle portion 840. Body 810 can have a tapering width from the handle portion 840 to the beveled edge 835. In one arrangement, the bottom edge of the body 810 lies in a plane that is generally parallel to a majority (e.g., 70-99.99% and all values and ranges therebetween) or all of a longitudinal axis of the handle portion 840, and the top edge of the body 810 lies in a plane that is non-parallel to a majority (e.g., 70-99.99% and all values and ranges therebetween) or all of a longitudinal axis of the handle portion 840. The longitudinal length of handle portion 840 is generally less than a longitudinal length of body 810. The average width of the handle portion 840 is generally greater than an average width of body 810

When the spatula 700 and the insertion tool 800 are coupled or formed together: (i) the overall length of the single tool is about 5-12 inches (and all values and ranges therebetween), and typically 6-10 inches; and (ii) the thickness of the single tool is about 0.1-3 inches (and all values and ranges therebetween), and typically 0.15-0.5 inches.

In one non-limiting embodiment, the longitudinal length of the front portion 720 of the spatula 700 is less than the longitudinal length of the handle portion 730 of the spatula 700. In one non-limiting specific example, the maximum width of the front portion 720 of the spatula 700 is about 1.5-8 inches (and all values and ranges therebetween), and typically 2-5 inches. The longitudinal length of the front portion 720 of the spatula 700 is about 1.5-8 inches (and all values and ranges therebetween), and typically 2-4 inches. In one non-limiting embodiment, the longitudinal length of the handle portion 730 of the spatula 700 is about 3-10 inches (and all values and ranges therebetween), and typically 4-6 inches. In one non-limiting embodiment, the maximum width of the handle portion 730 is about 1-3 in. (and all values and ranges therebetween), and typically 1.25-2 inches. It is to be appreciated that the width and/or thickness of the handle portion 730 can be constant along its longitudinal length. In one non-limiting embodiment, the beveled front edge 725 is angled at about 20-80° (and all values and ranges therebetween), and typically 30-60°. In one non-limiting embodiment, the average thickness of the front portion 720 is substantially equivalent to the average thickness of the handle portion 730.

In one non-limiting embodiment, the handle portion 840 of the insertion tool 800 has a longitudinal length of about 3-10 inches (and all values and ranges therebetween), and typically 4-6 inches. In one non-limiting embodiment, the maximum width of the handle portion 840 is about 1-3 inches (and all values and ranges therebetween), and typically 1.25-2 inches. It is to be appreciated that the width and/or thickness of the handle portion 840 can be constant along its longitudinal length. In one non-limiting embodiment, the body 810 has a longitudinal length of about 3-12 inches (and all values and ranges therebetween), and typically 6-9 inches. In one non-limiting embodiment, the maximum width of the body 810 about 1-3 inches (and all values and ranges therebetween), and typically 1.25-2 inches. In one non-limiting embodiment, the width of the body 810 generally varies along a majority of its longitudinal length, and typically reduces in width from the proximal end 820 to the distal end 830. In one non-limiting embodiment, the thickness of the body 810 can optionally be constant along its longitudinal length, and the width of the body 810 can vary along its longitudinal length.

It should be understood, however, that all of these and similar terms are to be associated with the appropriate physical quantities and are merely convenient labels applied to these quantities.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. These and other modifications of the preferred embodiments as well as other embodiments of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

The description of embodiments and examples has been presented for purposes of illustration and description. It is not intended to be exhaustive or limiting to the forms described.

Numerous modifications are possible in light of the teachings herein. Some of those modifications have been discussed, and others will be understood by those skilled in the art. The embodiments were chosen and described in order to illustrate principles of various embodiments as are suited to particular uses contemplated. The scope is, of course, not limited to the examples set forth herein, but can be employed in any number of applications and equivalent devices by those of ordinary skill in the art.

To aid the Patent Office and any readers of this application and any resulting patent in interpreting the claims appended hereto, applicants do not intend any of the appended claims or claim elements to invoke 35 U.S.C. 112 (f) unless the words “means for” or “step for” are explicitly used in the particular claim.

What is claimed:

1. A multi-purpose tool, the multi-purpose tool comprising:
a first tool portion that is configured to mix or spread at least one material, wherein the first tool portion is located at a first end of a handle member; and
a second tool portion comprising an elongated body having a proximal end and a distal end, wherein the proximal end is located at a second end of the handle member; and
wherein said first and second tool portions have different configurations.

2. The multi-purpose tool of claim 1, wherein the first tool portion comprises a substantially flat body having a rear portion and a front portion that has a beveled front edge.

3. The multi-purpose tool of claim 2, wherein the rear portion tapers inward towards the first end of the handle member, wherein the front portion has a first predetermined width and the rear portion has a second predetermined width, and wherein the first predetermined width is greater than the second predetermined width.

4. The multi-purpose tool of claim 2, wherein the first tool portion is a spatula.

5. The multi-purpose tool of claim 1, wherein the first tool portion is integrally formed with the first end of the handle member, and wherein the second tool portion is integrally formed with the second end of the handle member.

6. The multi-purpose tool of claim 1, wherein the first tool portion is coupled to the first end of the handle member, and wherein the second tool portion is coupled to the second end of the handle member.

7. The multi-purpose tool of claim 1, wherein the distal end of the second tool portion includes a beveled edge.

8. The multi-purpose tool of claim 1, wherein the elongated body of the second tool portion includes a first portion and a second portion, wherein the first portion is offset from the second portion.

9. The multi-purpose tool of claim 1, wherein the second tool portion is a tuck pointer.

10. The multi-purpose tool of claim 1, wherein the multi-purpose tool facilitates the installation of at least one fiber reinforced polymer in at least one slot that is formed in a structure, and wherein the at least one material is an adhesive that is configured for use with the at least one fiber reinforced polymer.

11. The multi-purpose tool of claim 1, wherein the multi-purpose tool has a longitudinal length of 14-18 inches, and wherein the multi-purpose tool has a maximum thickness of 0.15-0.5 inches.

12. A packaging insert comprising the first tool portion and the second tool portion of claim 1, wherein the packaging insert further comprises a surface member, and wherein the packaging insert is formed of a single piece of material that includes a plurality of perforations separating the first tool portion, the second tool portion, and the surface member.

13. A tool that facilities the installation of a fiber reinforced polymer in a concrete structure, the tool comprising:
a spatula having a beveled front edge that is configured to mix or spread at least one adhesive, wherein the spatula is integrally formed with a first end of a handle member; and
an insertion tool having an elongated body that is configured to insert the at least one adhesive and a fiber reinforced polymer in at least one slot formed in a concrete structure, wherein the elongated body includes a proximal end and a distal end, wherein the proximal end is integrally formed with a second end of the handle member.

14. The tool of claim 13, wherein the spatula comprises a substantially flat body having a rear portion and a front portion, wherein the rear portion is integrally formed with the first end of the handle member, and wherein the front portion includes the beveled front edge.

15. The tool of claim 14, wherein the rear portion tapers inward towards the first end of the handle member, wherein the front portion has a first predetermined width and the rear portion has a second predetermined width, and wherein the first predetermined width is greater than the second predetermined width.

16. The tool of claim 13, wherein the distal end of the insertion tool includes a beveled edge.

17. The tool of claim 13, wherein the elongated body of the insertion tool includes a first portion and a second portion, wherein the first portion is offset from the second portion.

18. The tool of claim 13, wherein the insertion tool is a tuck pointer.

19. The tool of claim 13, wherein the tool has a longitudinal length of 14-18 inches, and wherein the tool has a maximum thickness of 0.15-0.5 inches.

20. The tool of claim 14, wherein:
the rear portion of the spatula has a longitudinal length of 1.5-4 inches;
the front portion of the spatula has a longitudinal length of 2-4 inches;
the insertion tool has a longitudinal length of 5-11 inches; and
the handle member has a longitudinal length of 3-6 inches.
